(19) United States
(12) Patent Application Publication
(10) Pub. No.: US 2024/0219195 A1
(43) Pub. Date: Jul. 4, 2024

(54) SYSTEM AND METHOD FOR OPTIMIZATION OF LANE DATA

(71) Applicant: HERE Global B.V., Eindhoven (NL)

(72) Inventors: Zhenhua ZHANG, Pocatello, ID (US); Xiaoying JIN, Boulder, CO (US)

(21) Appl. No.: 18/090,082

(22) Filed: Dec. 28, 2022

(51) Int. Cl. G01C 21/00; G06F 16/28; G06F 16/29

(52) U.S. Cl. CPC G01C 21/3815; G06F 16/285; G06F 16/29

(57) ABSTRACT

The disclosure provides a system, a method, and a computer program product for optimization of lane data. The system may be configured to categorize each location of a set of locations included in the lane data of each lane marking of the plurality of lane markings, into at least one of: a first area or a second area of a topological area. The system may further determine the lane data of each lane marking to be in at least one of: a first group, a second group or a third group, based on each categorized location of the set of locations. The system may further process the lane data associated with each lane marking of the plurality of lane markings based on the determined first group, the second group or the third group.

### TECHNOLOGICAL FIELD

The present disclosure generally relates to digital map generation, and particularly relates to systems and methods for optimization of lane markings for generation of the digital map.

### BACKGROUND

Conventionally, generation of digital maps require data, such as lane data associated with lanes of a link. The lane data may be obtained by using various methods, for example, by use of satellite images, street-level images, light detection ranging data and the like. The lane data may include for example, representation of lane markings associated with the lane.

Typically, the lane data of detected lane markings of the lanes may be inaccurate. Further, the lane data of the lane markings associated with different topologies of the link may possess different problems. For instance, the lane data of the lane markings detected in a middle of the topology (such as an area that is away from an intersection of the link) may have gaps, overlapping geometries, incorrect orientation, and so forth. Thus, a method to correct the lane data of the lane markings detected in the middle of the topology, may need to consider factors such as lane count and lane width of the lane. On the other hand, the lane data of the lane markings detected at ends of the topology (such as an area that corresponds to the intersection of the link) may have problems, such as split or merged lane markings, road intersection locations and curved geometries. Thus, a method to correct the lane data of the lane markings detected at ends of the topology may need to consider factors such as connectivity of the lane markings and linear feature smoothing. However, the conventional methods for correcting the lane data of the detected lane markings may be inefficient and may fail to accurately correct the lane data associated with different topologies.

Therefore, there is a need for improved system and method for optimization of the lane data of the lane markings associated with different topologies.

### BRIEF SUMMARY

The following presents a simplified summary in order to provide a basic understanding of some novel embodiments described herein. This summary is not an extensive overview; and it is not intended to identify key/critical elements or to delineate the scope thereof. Some concepts are presented in a simplified form as a prelude to the more detailed description that is presented later.

The present disclosure provides a system, a method, and a computer programmable optimization of a plurality of lane markings.

In conventional systems, lane markings associated with different topologies may be processed using a single model to correct anomalies in lane data of the lane markings. For instance, the lane data of the lane markings detected in a middle of the topology (such as an area that is away from an intersection of a link) may have gaps, overlapping geometries, incorrect orientation, and so forth. Further, the lane data of the lane markings detected at ends of the topology (such as an area that corresponds to the intersection of the link) may have problems, such as split or merged lane markings, road intersection locations and curved geometries. Thus, utilization of the single model to process the lane data of the detected lane markings associated with different topologies may be inefficient and may lead to inaccurate correction of the lane data of the lane markings. On the other hand, the system of the present disclosure may enable categorization of the lane data of the lane markings based on a type of a topological area. For example, the system may categorize the lane data associated with the lane markings based on a determination that the lane data lies in a first area of the topological area, or the lane data lies in a second area of the topological area, or the lane data lies in both the first area and the second area of the topological area. Thus, the lane data of the lane markings with different types of anomalies may be categorized in different groups. The system may further apply different types of models on the categorized lane data of the lane markings for processing the lane data of the lane markings. The system may further connect the processed lane data by use of the different types of models. Thus, the system of the present disclosure may enable efficient and accurate correction of the lane data associated with the lane markings.

Some example embodiments disclosed herein provide a system for optimization of lane data. The system comprises a memory configured to store computer-executable instructions and one or more processors configured to execute the instructions to categorize each location of a set of locations included in the lane data of each lane marking of the plurality of lane markings, into at least one of a first area or a second area of a topological area. The one or more processors are further configured to determine the lane data of each lane marking to be in at least one of a first group, a second group or a third group, based on each categorized location of the set of locations. The one or more processors are further configured to process the lane data associated with each lane marking of the plurality of lane markings based on the determined first group, the second group or the third group.

According to some example embodiments, the at least one processor is further configured to categorize the topological area associated with a map, into the first area and the second area, based on a type of the topological area.

According to some example embodiments, to categorize the topological area, the at least one processor is further configured to generate a border between the first area and the second area to separate the first area from the second area. The at least one processor may further determine a buffer area for each of the first area and the second area. The buffer area may be further utilized to categorize the set of locations into at least one of the first area or the second area of the topological area.

According to some example embodiments, the type of the topological area comprises one of an intersection or a non-intersection, a ramp area or a non-ramp area, and a highway or a non-highway.

According to some example embodiments, the first area corresponds to one of the intersection, the ramp area or the highway. The second area corresponds to on one of the non-intersection, the non-ramp area or the non-highway.

According to some example embodiments, to process the lane data, the at least one processor is further configured to truncate the lane data of one or more lane markings of the plurality of lane markings determined in the third group. The third group is associated with both of the first area and the second area. The at least one processor may further apply a first model on the lane data determined in the first group and a first portion of the truncated lane data determined in the third group, and a second model on the lane data determined in the second group and a second portion of the truncated lane data determined in the third group. Furthermore, the at least one processor may connect the truncated lane data by use of a generated line connector to optimize the lane data.

According to some example embodiments, the at least one processor is further configured to determine an on-line threshold that indicates an amount of a positional shift required by the lane data of first lane marking and a second lane marking of the one or more lane markings. The at least one processor may further determine a gap threshold that indicates a distance between a first location of the lane data of the first lane marking and a second location of the lane data of the second lane marking. Furthermore, the at least one processor may generate the line connector to optimize the lane data of the first lane marking and the second lane marking based on at least one of: the determined on-line threshold or the determined gap threshold.

According to some example embodiments, to categorize each location of the set of locations, the at least one processor is further configured to determine a reference node corresponding to a first end of a line string associated with a lane and a non-reference node corresponding to a second end point of the line string associated with the lane. The plurality of lane markings are associated with the lane. The at least one processor may further categorize at least a first location of the set of locations into the first area based on a determination that the first location lies within a predefined threshold of at least one of: the reference node or the non-reference node, wherein the reference node and the non-reference node are associated with the first area: and the first location lies within a buffer area for the first area, wherein the buffer area is determined with respect to the reference node and the non-reference node.

According to some example embodiments, the at least one processor is further configured to categorize the first location into the first area based on at least one of: a map matching method or a point-in polygon method.

According to some example embodiments, to process the lane data, the at least one processor is further configured to truncate the lane data of one or more lane markings of the plurality of lane markings determined in the third group in two lane markings, based on a determination that the first location of the lane data of each lane marking of the one or more lane markings lies within the predefined threshold of at least one of: the reference node or the non-reference node, and a second location of the lane data of each lane marking is categorized in the second area.

According to some example embodiments, to process the lane data, the at least one processor is further configured to truncate the lane data of the one or more lane markings in three lane markings, based on a determination that the first location of the lane data of each lane marking lies within the predefined threshold of the reference node, and the second location of the lane data of each lane marking lies within the predefined threshold of the non-reference node.

Some example embodiments disclosed herein provide a method for optimization of lane data. The method may include categorization of each location of a set of locations included in the lane data of each lane marking of the plurality of lane markings, into at least one of a first area or a second area of a topological area. The method may further include determination of the lane data of each lane marking to be in at least one of a first group, a second group or a third group, based on each categorized location of the set of locations. The method may further include processing the lane data associated with each lane marking of the plurality of lane markings based on the determined first group, the second group or the third group.

According to some example embodiments, the method further comprises generating a border between the first area and the second area to separate the first area from the second area. Further, the method may comprise determining a buffer area for each of the first area and the second area. The buffer area may further be utilized to categorize the set of locations into at least one of the first area or the second area of the topological area, to categorize the topological area.

According to some example embodiments, the method further comprises truncating the lane data of one or more lane markings of the plurality of lane markings determined in the third group. The third group is associated with both of the first area and the second area. The method further comprises applying a first model on the lane data determined in the first group and a first portion of the truncated lane data determined in the third group, and a second model on the lane data determined in the second group and a second portion of the truncated lane data determined in the third group. The method further comprises connecting the truncated lane data by use of a generated line connector to optimize the lane data, to process the lane data.

According to some example embodiments, the method further comprises determining an on-line threshold that indicates an amount of a positional shift required by the lane data of first lane marking and a second lane marking of the one or more lane markings. Further, the method comprises determining a gap threshold that indicates a distance between a first location of the lane data of the first lane marking and a second location of the lane data of the second lane marking. The method may further comprise generating the line connector to optimize the lane data of the first lane marking and the second lane marking based on at least one of the determined on-line threshold or the determined gap threshold.

According to some example embodiments, the method further comprises determining a reference node corresponding to a first end of a line string associated with a lane and a non-reference node corresponding to a second end point of the line string associated with the lane. The plurality of lane markings are associated with the lane. The method further comprises categorizing at least a first location of the set of locations into the first area based on a determination that the first location lies within a predefined threshold of at least one of: the reference node or the non-reference node, wherein the reference node and the non-reference node are associated with the first area, and the first location lies within a buffer area for the first area, wherein the buffer area is determined with respect to the reference node and the non-reference node.

According to some example embodiments, the method further comprises categorizing the first location into the first area based on at least one of a map matching method or a point-in polygon method.

According to some example embodiments, the method further comprises truncating the lane data of one or more lane markings of the plurality of lane markings determined in the third group in two lane markings, based on a determination that the first location of the lane data of each lane marking of the one or more lane markings lies within the predefined threshold of at least one of: the reference node or the non-reference node, and a second location of the lane data of each lane marking is categorized in the second area, to process the lane data.

According to some example embodiments, the method further comprises truncating the lane data of the one or more lane markings in three lane markings, based on a determination that the first location of the lane data of each lane marking lies within the predefined threshold of the reference node, and the second location of the lane data of each lane marking lies within the predefined threshold of the non-reference node, to process the lane data.

Some example embodiments disclosed herein provide a computer programmable product comprising a non-transitory computer readable medium having stored thereon computer executable instruction which when executed by one or more processors, cause the one or more processors to carry out operations for optimization of lane data. The operations comprise categorizing each location of a set of locations included in the lane data of each lane marking of the plurality of lane markings, into at least one of a first area or a second area of a topological area. The operations further comprise determining the lane data of each lane marking to be in at least one of a first group, a second group or a third group, based on each categorized location of the set of locations. The operations further comprise processing the lane data associated with each lane marking of the plurality of lane markings based on the determined first group, the second group or the third group.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

Having thus described example embodiments of the invention in general terms, reference will now be made to the accompanying drawings, which are not necessarily drawn to scale, and wherein:

FIG. 1 illustrates a network environment of a system for optimization of a plurality of lane markings, in accordance with an example embodiment:

FIG. 2 illustrates a block diagram of a system for optimization of the plurality of lane markings, in accordance with an example embodiment:

FIG. 3 illustrates a schematic diagram for categorization of a topological area, in accordance with an example embodiment:

FIG. 4 illustrates a schematic diagram for categorization of a set of locations included in lane data of each lane marking of the plurality of lane markings, in accordance with an example embodiment:

FIG. 5A and FIG. 5B collectively illustrate schematic diagrams for grouping and truncation of the lane data, in accordance with an example embodiment:

FIG. 6 illustrates a schematic diagram for the categorized set of locations, in accordance with an example embodiment:

FIG. 7A and FIG. 7B collectively illustrate schematic diagrams for connecting the lane data by use of a line connector, in accordance with an example embodiment:

FIG. 8A and FIG. 8B collectively illustrate schematic diagrams representing the lane data before and after connecting with the line connector, in accordance with an example embodiment:

FIG. 9 illustrates a block diagram representing steps for optimization of the lane data, in accordance with an example embodiment: and

FIG. 10 illustrates a flow diagram of a method for optimization of the lane data, in accordance with an example embodiment.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details. In other instances, systems, apparatuses, and methods are shown in block diagram form only in order to avoid obscuring the present disclosure.

Reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. Further, the terms “a” and “an” herein do not denote a limitation of quantity, but rather denote the presence of at least one of the referenced items. Moreover, various features are described which may be exhibited by some embodiments and not by others. Similarly, various requirements are described which may be requirements for some embodiments but not for other embodiments.

Some embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

Additionally, as used herein, the term ‘circuitry’ may refer to (a) hardware-only circuit implementations (for example, implementations in analog circuitry and/or digital circuitry): (b) combinations of circuits and computer program product(s) comprising software and/or firmware instructions stored on one or more computer readable memories that work together to cause an apparatus to perform one or more functions described herein: and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein, a “computer-readable storage medium,” which refers to a non-transitory physical storage medium (for example, volatile or non-volatile memory device), can be differentiated from a “computer-readable transmission medium,” which refers to an electromagnetic signal.

The embodiments are described herein for illustrative purposes and are subject to many variations. It is understood that various omissions and substitutions of equivalents are contemplated as circumstances may suggest or render expedient but are intended to cover the application or implementation without departing from the spirit or the scope of the present disclosure. Further, it is to be understood that the phraseology and terminology employed herein are for the purpose of the description and should not be regarded as limiting. Any heading utilized within this description is for convenience only and has no legal or limiting effect.

### Definitions

The term “route” may be used to refer to a path from a source location to a destination location on any link.

The term “autonomous vehicle” may refer to any vehicle having autonomous driving capabilities at least in some conditions. An autonomous vehicle, as used throughout this disclosure, may refer to a vehicle having autonomous driving capabilities at least in some conditions. The autonomous vehicle may also be known as a driverless car, robot car, self-driving car, or autonomous car. For example, the vehicle may have zero passengers or passengers that do not manually drive the vehicle, but the vehicle drives and maneuvers automatically. There can also be semi-autonomous vehicles.

The term “machine learning model” may be used to refer to a computational or statistical or mathematical model that is based in part or on the whole on artificial intelligence and deep learning techniques. The “machine learning model” is trained over a set of data and using an algorithm that it may use to learn from the dataset.

The term “deep learning” is a type of machine learning that utilizes both structured and unstructured data for training.

### End of Definitions

Embodiments of the present disclosure may provide a system, a method, and a computer program product for optimization of lane markings.

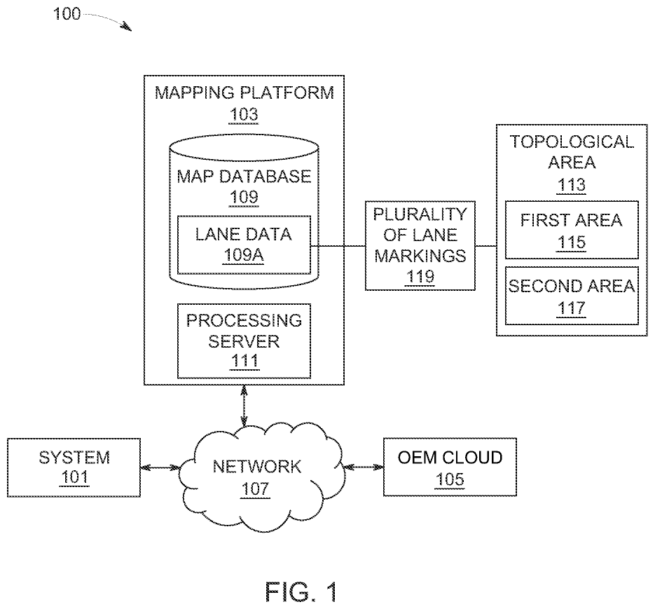

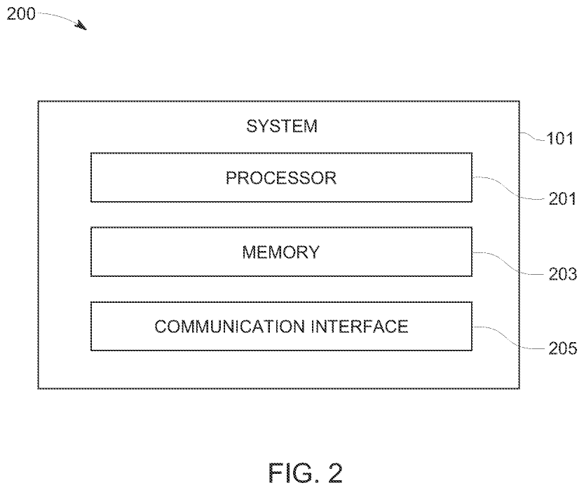

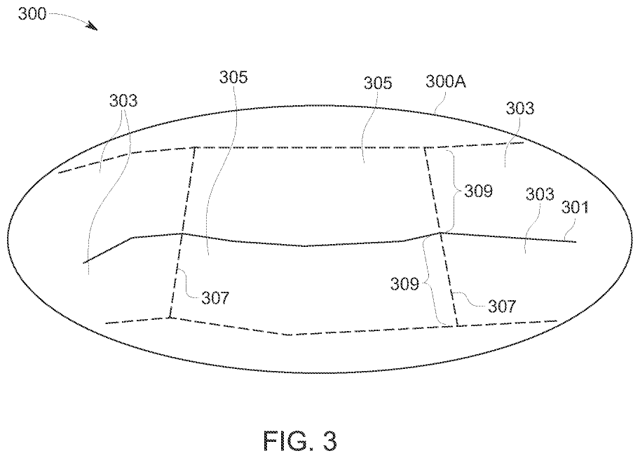

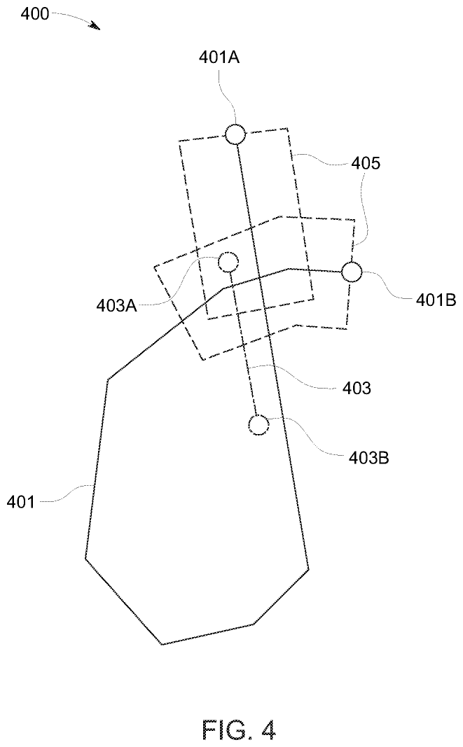

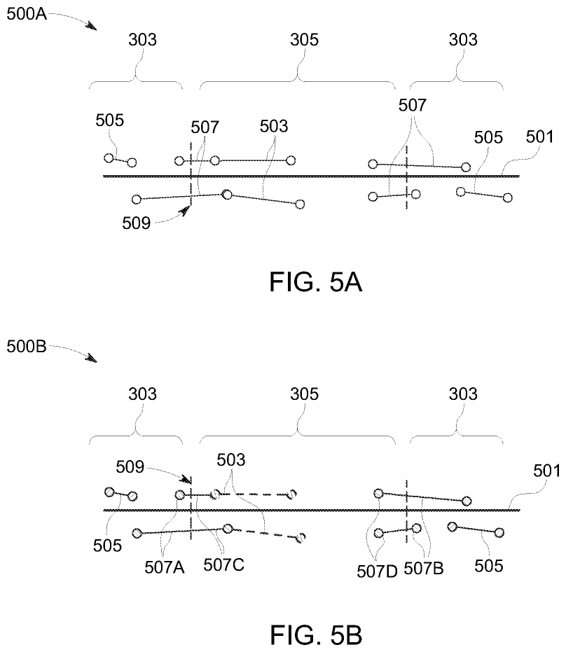

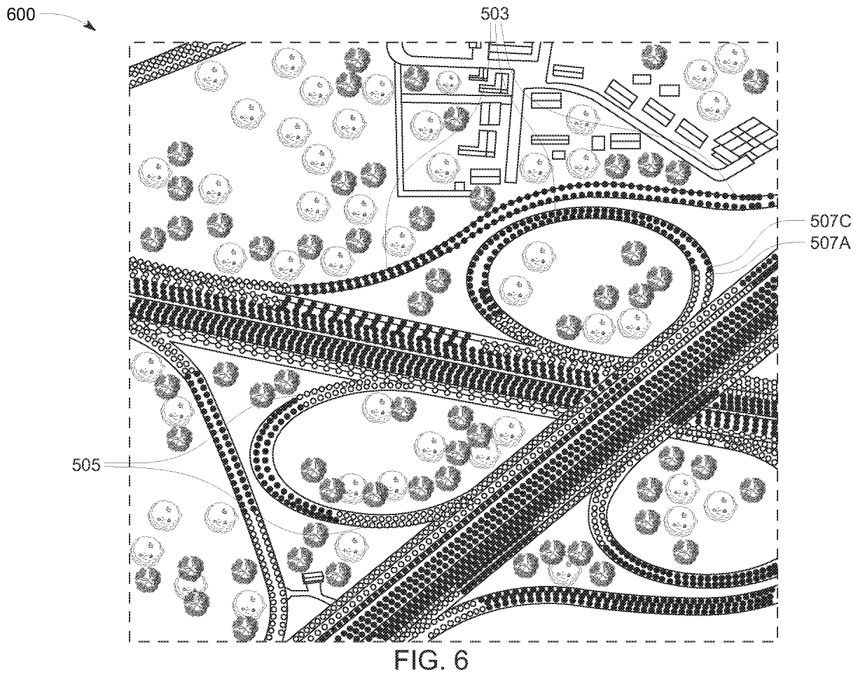

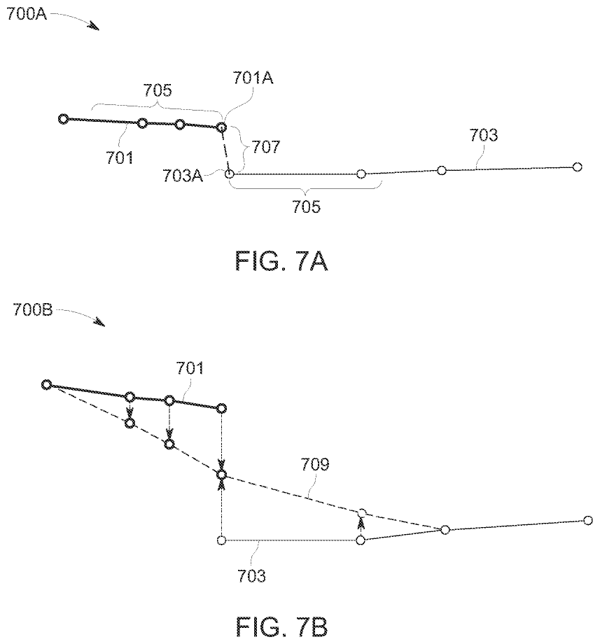

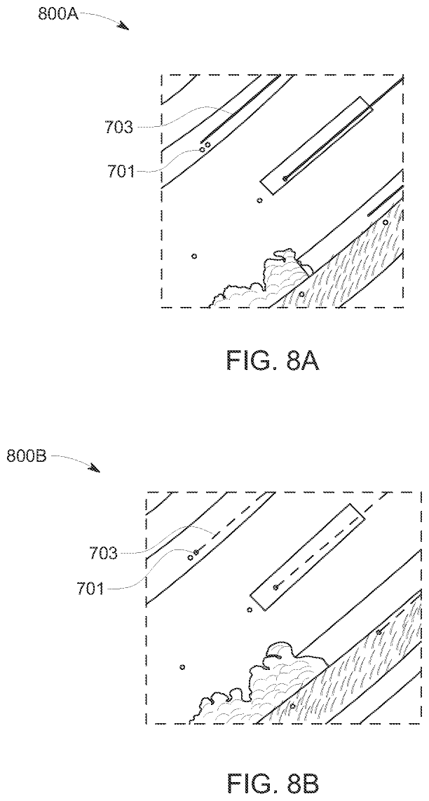

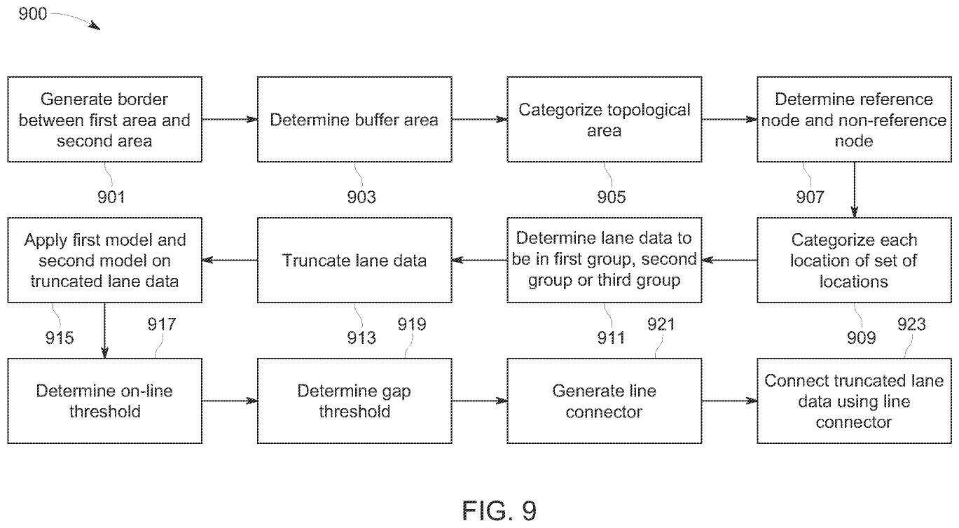

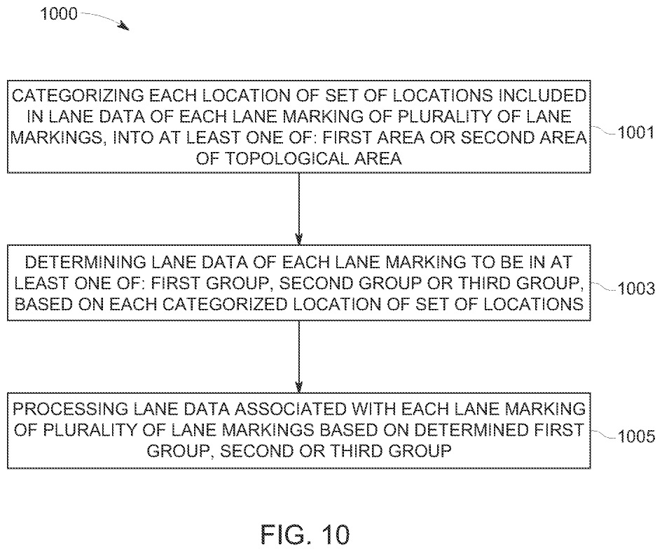

Generally, conventional systems may rely on processing the lane markings of different topologies in a similar manner. Such systems may lead to inaccurate correction of the lane markings, thereby leading to generation of inaccurate digital maps. Therefore, there is a need for a system that processes the lane markings based on a type of the topology, thus enabling accurate correction or optimization of the lane markings. The system, the method, and the computer program product facilitating the optimization of the lane markings are described with reference to FIG. 1, FIG. 2, FIG. 3, FIG. 4, FIG. 5A, FIG. 5B, FIG. 6, FIG. 7A, FIG. 7B, FIG. 8A, FIG. 8B, FIG. 9 and FIG. 10. as detailed below.

FIG. 1 illustrates a network environment 100 of a system 101 for optimization of a plurality of lane markings, in accordance with an example embodiment. The system 101 may be communicatively coupled to a mapping platform 103, and an OEM (Original Equipment Manufacturer) cloud 105 via a network 107. The mapping platform 103 may further include a map database 109 and a processing server 111. The map database 109 may further include lane data 109A. Furthermore, the network environment 100 may include a topological area 113. The topological area 113 may include a first area 115 and a second area 117. The network environment 100 may further include a plurality of lane markings 119 associated with the topological area 113. The lane data 109A may be associated with the plurality of lane markings 119.

The components described in the network environment 100 may be further broken down into more than one component such as applications in the system 101 and/or combined together in any suitable arrangement. Further, it is possible that one or more components may be rearranged, changed, added, and/or removed.

The system 101 may be configured to perform one or more operations, such as categorizing a set of locations included in the lane data 109A of each lane marking of the plurality of lane markings 119, into at least one of the first area 115 or the second area 117 of the topological area 113. Further, the system 101 may determine the lane data 109A of each lane marking to be in a first group, a second group or a third group, based on each categorized location of the set of locations. Based on the determined first group, the second group or the third group, the system 101 may process the lane data 109A associated with each lane marking of the plurality of lane markings 119. Details of the one or more operations of the system 101 are further described in detail, for example, in FIG. 3, FIG. 4, FIG. 5A, FIG. 5B, FIG. 6, FIG. 7A, FIG. 7B, and FIG. 9.

The lane data 109A may include data associated with lane markings of the road. The lane data 109A may be associated with the plurality of lane markings 119 of links or the roads in the topological area 113. For example, the lane data 109A may include a lane-level representation of the lane including the plurality of lane markings 119 of the lane or the links. In an exemplary scenario, the lane data 109A may be generated from images of the plurality of lane markings 119 captured by use of one or more imaging devices. For example, the images may be acquired by a satellite. In another example, the images may be acquired by imaging devices associated with a vehicle, such as an autonomous vehicle. The imaging device associated with the vehicle may be for example, a light detection and ranging (LiDAR) or a surround-view 360 camera. The lane data 109A may be utilized in various applications, such as for generation of the map data to improve a driver's awareness, safety, and comfort. The topological area 113 may correspond to a representation of a geographical location. Examples of types of the topological area 113 may include, but may not be limited to, an intersection or a non-intersection, a ramp area or a non-ramp area, and a highway or a non-highway. In an embodiment, the first area 115 may be one of the intersection, the ramp area or the highway. In one or more embodiments, the second area 117 may be one of the non-intersection, the non-ramp area or the non-highway.

The plurality of lane marking 119 may represent lines or shapes corresponding to the lane or the road in the topological area 113. Examples of the plurality of lane marking 119 may include, but may not be limited to, road lane markings, traffic lane markings, highway lane markings, reversible lane markings, pavement arrows, edge lines of the road, and pavement markings.

In operation, the lane data 109A may be generated or obtained by using various methods, for example, by use of satellite images, or street-level images and stored in the map database 109. However, the lane data 109A stored in the map database 109 may be inaccurate. For example, the lane data 109A associated with lane markings of the plurality of lane markings 119 detected in the first area 115 of the topological area 113 may have split or merged lane markings, road intersection locations and curved geometries. Moreover, the lane data 109A associated with lane markings of the plurality of lane markings 119 detected in the second area 117 of the topological area 113 may have gaps, overlapping geometries, incorrect orientation, and so forth. As a first step to correct the incorrect lane data 109A, in some embodiments, the system 101 may categorize the topological area 113 associated with a map of the geographical location, into the first area 115 and the second area 117, based on the type of the topological area. Details of the categorization of the topological area 113 are further provided, for example, in FIG. 3.

Furthermore, the system 101 may further categorize each location of a set of locations included in the lane data 109A of each lane marking of the plurality of lane markings 119, into at least one of the first area 115 or the second area 117 of the topological area 113. For example, a location of set of locations may be an end of the lane marking of the plurality of lane markings 119. Details of the categorization of each location of the set of locations are further provided, for example, in FIG. 4.

The system 101 may further determine the lane data 109A of each lane marking of the plurality of lane markings 119 to be in at least one of a first group, a second group or a third group, based on each categorized location of the set of locations. For example, the lane data 109A may be determined to be in different groups, such as the first group, the second group and the third group to identify a portion of the lane data 109A that lies in the first area 115, a portion of the lane data 109A that lies in the second area 117, or a portion of the lane data 109A that lies both the areas. Details of the determination of the lane data 109A in the different groups are further provided, for example, in FIG. 5A and FIG. 5B.

Furthermore, the system 101 may process the lane data 109A associated with each lane marking of the plurality of lane markings 119 based on the determined first group, the second group or the third group. For example, the processing may include truncation of the lane data 109A, applying different models on the truncated lane data 109A and connecting the truncated lane data 109A by use of a line connector. The processing of the lane data 109A may lead to optimization of the lane data 109A. For example, the optimization of the lane data 109A may include updating the geographical coordinates of the lane data 109A, connecting broken lines in the lane data 109A, correcting overlapping lines in the lane data 109A and the like. Details of the processing of the lane data 109A are further provided, for example, in FIG. 5A, FIG. 5B, FIG. 7A and FIG. 7B.

FIG. 2 illustrates a block diagram 200 of the system 101 for optimization of the plurality of lane markings 119, in accordance with an example embodiment. The system 101 may include a processing means such as at least one processor 201 (hereinafter, also referred to as “processor 201”), storage means such as at least one memory 203 (hereinafter, also referred to as “memory 203”), and a communication means such as at least one communication interface 205 (hereinafter, also referred to as “communication interface 205”). The processor 201 may retrieve computer program code instructions that may be stored in the memory 203 for execution of the computer program code instructions.

FIG. 3 illustrates a schematic diagram 300 for categorization of a topological area 300A, in accordance with an example embodiment. The topological area 300A includes a line string 301 associated with a lane in the topological area 300A. The topological area 300A includes a first area 303 and a second area 305. In some embodiments, the processor 201 may be configured to categorize the topological area 300A associated with the map, into the first area 303 and the second area 305, based on a type of the topological area 300A. For example, the first area 303 may be ends of the topological area 300A. The second area 305 may be a middle of the topological area 300A.

In some embodiments, the type of the topological area 300A may include one of an intersection or a non-intersection, a ramp area or a non-ramp area, and a highway or a non-highway. For example, the topological area 300A may correspond to a geographical location that includes intersection of multiple links or the roads. In such a case, portions of the topological area 300A that has intersecting links may be categorized from portions of the topological area 300A having no intersections. Similarly, the topological area 300A may correspond to a geographical location having the ramp area and the non-ramp area associated with the links. The topological area 300A may further correspond to a geographical location having highway and non-highway areas.

In some embodiments, the first area 303 may correspond to one of the intersection, the ramp area or the highway of the topological area 300A. For example, the first area 303 may be the ends of the topological area 300A that includes the intersection of the multiple links or the roads. The second area 305 may correspond to on one of the non-intersection, the non-ramp area or the non-highway. For example, the second area 305 may be the middle of the topological area 300A that includes no intersections of the links.

In some embodiments, to categorize the topological area, the processor 201 may be further configured to generate a border 307 between the first area 303 and the second area 305 to separate the first area 303 from the second area 305. The border 307 may be generated by use of perpendicular lines drawn on the line string 301 at the ends of the non-intersection portion of the topological area 300A. In other words, the perpendicular lines may be drawn at the ends of the second area 305, to separate the second area 305 from the first area 303. Thus, the first area 303 may be present at both ends of the second area 305. The processor 201 may be further determine a buffer area 309 for each of the first area 303 and the second area 305. The buffer area 309 may be determined by drawing parallel lines on both sides of the line string 301 at a predefined distance. The buffer area 309 may be further utilized to categorize a set of locations of the lane data 109A into at least one of the first area 303 or the second area 305 of the topological area 300A. Details of the categorization of the set of locations of the lane data 109A are further provided, for example, in FIG. 4.

FIG. 4 illustrates a schematic diagram 400 for categorization of a set of locations included in the lane data 109A of each lane marking of the plurality of lane markings 119, in accordance with an example embodiment. The schematic diagram 400 may include a line string 401 associated with a lane in the topological area 300A. In an embodiment, the line string 401 and the line string 301 may be associated with different lanes in the topological area 300A. The lane data 109A may be associated with each of the line strings, such as the line string 301 and the line string 401 of each lane associated with the topological area 300A.

The line string 401 may be for example, a representation of the lane in the topological area 300A. The line string 401 includes a reference node 401A and a non-reference node 401B. The schematic diagram 400 may further include lane data 403 of a lane marking of the plurality of lane markings 119. The lane data 403 further includes a first location 403A and a second location 403B of the set of locations. In an embodiment, the lane data 403 may be a part of the lane data 109A stored in the map database 109.

The processor 201 may be configured to categorize each location, such as the first location 403A and the second location 403B of the set of locations included in the lane data 403 of each lane marking of the plurality of lane markings 119, into at least one of the first area 303 or the second area 305 of the topological area 300A. For example, a location may correspond to an end point of the lane data 403 of each lane marking. The first location 403A may be a first end of the lane data 403. Similarly, the second location 403B may be a second end of the lane data 403. The set of locations may further correspond to geographical coordinates of the ends of the lane in the geographical location associated with the topological area 300A.

In some embodiments, the processor 201 may be further configured to categorize each location of the set of locations into one of the first area 303 or the second area 305 of the topological area 300A based on at least one of a map matching method or a point-in polygon method. The map matching method may include matching of the set of locations to the geographical coordinates in the geographical location associated with the topological area 300A. The map matching method may utilize, for example, geographic information system (GIS) for matching of the set of locations to the geographical coordinates. Moreover, the point-in polygon method may be utilized to determine one or more locations of the set of locations that may lie within a buffer area 405 or outside the buffer area 405. The buffer area 405 associated with the line string 401 may be determined in a similar manner the buffer area 309 associated with the line string 301 is determined.

In some embodiments, to categorize the first location 403A and the second location 403B of the set of locations, the processor 201 may be further configured to determine the reference node 401A corresponding to a first end of the line string 401 associated with a lane and the non-reference node 401B corresponding to a second end point of the line string 401 associated with the lane. For example, the first end of the line string 401 and the second end point of the line string 401 may lie in the intersection area of the topological area 300A. The reference node 401A and the non-reference node 401B may correspond to the geographical coordinates of the ends of the line string 401 of the lane in the topological area 300A. In an embodiment, the processor 201 may determine the reference node 401A and the non-reference node 401B by use of the map matching method.

The processor 201 may categorize each of the set of locations to lie in the first area 303 or the second area 305 based on a predefined threshold and the buffer area 405. In some embodiments, the processor 201 may categorize the first location 403A of the set of locations into the first area 303 based on a determination that the first location 403A lies within the predefined threshold of at least one of the reference node 401A or the non-reference node 401B. The reference node 401A and the non-reference node 401B are associated with the first area 303 (for example, the intersection area). For example, the predefined threshold may be an area of a few meters surrounding the reference node 401A or the non-reference node 401B. Furthermore, the processor 201 may determine that the first location 403A lies within the buffer area 405 or a bounding box for the first area 303. The buffer area 405 may further be determined with respect to the reference node 401A and the non-reference node 401B. Similarly, for the second location 403B, the processor 201 may determine if the second location 403B lies within the predefined threshold and the buffer area 405. For example, the second location 403B lies outside the predefined threshold of both the reference node 401A or the non-reference node 401B. Further, the second location 403B lies outside the buffer area 405. In such a case, the second location 403B may be categorized in the second area 305 of the topological area 300A. In an embodiment, the processor 201 may categorize each of the set of locations to lie in the first area 303 or the second area 305 by use of the point-in polygon method. Once each location of the set of locations of the lane data 403 and a set of locations of each lane data in the lane data 109A are categorized in the first area 303 or the second area 305, each lane data in the lane data 109A may be determined to be in one or more groups. Details of the determination of each lane data in the lane data 109A are further provided, for example, in FIG. 5A and FIG. 5B.

FIG. 5A and FIG. 5B collectively illustrate schematic diagrams for grouping and truncation of the lane data 109A, in accordance with an example embodiment. FIG. 5A illustrates a schematic diagram 500A. The schematic diagram 500A includes a line string 501. In an embodiment, the line string 501, the line string 401 and the line string 301 may be associated with different lanes in the topological area 300A.

The schematic diagram 500A may further include lane data 503, lane data 505 and lane data 507 included in the lane data 109A. The schematic diagram 500A may further include a generated border 509 to separate the first area 303 from the second area 305 of the topological area 300A.

The processor 201 may be further configured to determine the lane data, such as the lane data 503, the lane data 505 and the lane data 507 of each lane marking to be in at least one of a first group, a second group or a third group, based on each categorized location of the set of locations. For example, the first group may include the lane data of the lane data 109A that lies in the first area 303 of the topological area 300A. The second group may include the lane data of the lane data 109A that lies in the second area 305 of the topological area 300A. The third group may include the lane data of the lane data 109A that lies in both the first area 303 and the second area 305 of the topological area 300A.

FIG. 5B illustrates a schematic diagram 500B. The schematic diagram 500B includes the line string 501. As shown, for example, the lane data 505 lies in the first area 303, thus the processor 201 may determine the lane data 505 to be in the first group. The lane data 503 lies in the second area 305, thus the processor 201 may determine the lane data 503 to be in the second group. The lane data 507 lies in both the first area 303 and the second area 305 as one or more locations of the lane data 507 lie in the first area 303 and one or more locations of the lane data 507 lie in the second area 305, thus the processor 201 may determine the lane data 507 to be in the third group.

The processor 201 may be further configured to process the lane data 109A associated with each lane marking of the plurality of lane markings 119 based on the determined first group, the second group or the third group. For example, the processor 201 may process the lane data 503 the lane data 505 and the lane data 507 to accurately correct the lane data 109A, based on the type of the topological area 300A.

In some embodiments, to process the lane data, the processor 201 may be further configured to truncate the lane data of one or more lane markings of the plurality of lane markings 119 determined in the third group. The third group is associated with both of the first area 303 and the second area 305. For example, the processor 201 may truncate the lane data 507 into different portions, such as a first portion and a second portion to process the lane data 307 that lies in different types of the topological area 300A separately. For example, the first area 303 is the intersection area and the second area 305 is the non-intersection area. For example, the first portion of the truncated lane data 507 may include a portion 507A and a portion 507B of the lane data 507. The second portion of the truncated lane data 507 may include a portion 507C and a portion 507D of the lane data 507.

In some embodiments, to process the lane data 109A, the processor 201 may further configured to truncate the lane data of one or more lane markings of the plurality of lane markings 119 determined in the third group in two lane markings. For example, the processor 201 may truncate the lane data 507 in two the lane markings. The processor 201 may truncate the lane data 507 in two the lane markings based on a determination that the first location of the lane data 507 lies within the predefined threshold of at least one of the reference node 401A or the non-reference node 401B, and a second location of the lane data 507 is categorized in the second area 305.

In a first scenario, the first location of the lane data 507 lies within the predefined threshold of the reference node 401A and the second location of the lane data 507 categorized in the second area 305. In such a case, the lane data 507 may be truncated as two smaller lane markings. For example, the first portion, such the portion 507A and the portion 507B of the truncated lane data 507 may be in the intersection area, such as the first area 303. The second portion, such as the portion 507C and the portion 507D of the truncated lane data 507 may be in the non-intersection area, such as the second area 305.

In a second scenario, the first location of the lane data 507 lies within the predefined threshold of the non-reference node 401B and the second location of the lane data 507 categorized in the second area 305. In such a case, the lane data 507 may be truncated as two smaller lane markings. Thus, the first portion, such the portion 507A and the portion 507B of the truncated lane data 507 may be in the intersection area, such as the first area 303. The second portion, such as the portion 507C and the portion 507D of the truncated lane data 507 may be in the non-intersection area, such as the second area 305.

In some embodiments, to process the lane data 109A, the processor 201 may further configured to truncate the lane data 507 of one or more lane markings of the plurality of lane markings 119 in three lane markings, based on a determination that the first location of the lane data 507 of each lane marking lies within the predefined threshold of the reference node 401A, and the second location of the lane data 507 of each lane marking lies within the predefined threshold of the non-reference node 401B.

In a third scenario, the first location of the lane data 507 lies within the predefined threshold of the reference node 401A and the second location of the lane data 507 lies within the predefined threshold of the non-reference node 401B. In such a case, the lane data 507 may be truncated as three smaller lane markings. Two portions of the three smaller lane markings may be in the intersection area, such as the first area 303, and one portion of the three smaller lane markings may be in the non-intersection area, such as the second area 305.

The processor 201 may apply a first model on the lane data 505 determined in the first group and the first portion of the truncated lane data 507 determined in the third group, and a second model on the lane data 503 determined in the second group and the second portion of the truncated lane data 507 determined in the third group.

The processor 201 may apply the first model on the lane data 505, and the first portion (such as the portion 507A and the portion 507B) of the truncated lane data 507 to accurately correct the lane data 109A. As the lane data 505, and the first portion (such as the portion 507A and the portion 507B) of the truncated lane data 507 lies in the intersection area, the first model may be configured to correct the problems such as split or merged lane markings included in the lane data 505 and the first portion of the truncated lane data 507. Similarly, the processor 201 may apply the second model on the lane data 503 and the second portion (such as the portion 507C and the portion 507D) of the truncated lane data 507. As the lane data 503 and the second portion (such as the portion 507C and the portion 507D) of the truncated lane data 507 lies in the non-intersection area, the second model may be configured to correct the problems such as gaps, overlapping geometries and incorrect orientation included in the lane data 503 and the second portion of the truncated lane data 507.

The processor 201 may further connect the truncated lane data 507 by use of a generated line connector to optimize the lane data 109A. As the lane data that lies in the different types of the topological area 300A are processed differently, the truncated lane data 507 needs to be connected using the line connector. Details of the generation of the line connector are further provided, for example, in FIG. 7A and FIG. 7B.

FIG. 6 illustrates a schematic diagram 600 for the categorized set of locations, in accordance with an example embodiment. The schematic diagram 600 may include an interchange type of the topological area 300A. The topological area 300A may include the intersection area and the non-intersection area.

The lane data 505 may be categorized into the first area 303 of the topological area 300A. The lane data 503 may be categorized in the second area 305 of the topological area 300A. The truncated lane data 507, such as the first portion (for example, the portion 507A) of the lane data 507 may be categorized in the first area 303 of the topological area 300A, and the second portion (for example, the portion 507C) of the lane data 507 may be categorized in the second area 305 of the topological area 300A. Thus, in such a manner the processor 201 may categorize each lane data in the lane data 109A based on the type of the topological area 300A. The processed lane data 109A by use of the first model and the second model is further connected using the line connector as explained further.

FIG. 7A and FIG. 7B collectively illustrate schematic diagrams for connecting the lane data by use of a line connector, in accordance with an example embodiment. FIG. 7A illustrates a schematic diagram 700A that includes lane data 701 of the lane data 109A processed using the first model. The schematic diagram 700A further includes lane data 703 of the lane data 109A processed using the second model. For example, the lane data 701 may include the first portion of the lane data 507. The lane data 703 may include the second portion of the lane data 507.

In some embodiments, the processor 201 may be further configured to determine an on-line threshold 705 that indicates an amount of a positional shift required by the lane data, such as the lane data 701 of first lane marking and the lane data 703 of a second lane marking of the one or more lane markings. The on-line threshold 705 may be an on-line length for the truncated lane data 507 that needs the positional shift. The processor 201 may further determine a gap threshold 707 that indicates a distance between a first location 701A of the lane data 701 of the first lane marking and a second location 703A of the lane data 703 of the second lane marking.

FIG. 7B illustrates a schematic diagram 700B that includes the lane data 701 and the lane data 703 that needs to be connected with a line connector 709. The processor 201 may further generate the line connector 709 to optimize the lane data 701 of the first lane marking and the lane data 701 of the second lane marking based on at least one of the determined on-line threshold 705 or the determined gap threshold 707. The generated line connector 709 may be utilized to connect the lane data 701 and the lane data 703. For example, the locations of the lane data 701 and the lane data 703 needs to be shifted towards each other. The shifting direction of the locations of the lane data 701 and the lane data 703 may be perpendicular to an orientation of the lane markings associated with the lane data 701 and the lane data 703. The shifting of the locations of the lane data 701 and the lane data 703 may lead to the generation of the line connector 709.

FIG. 8A and FIG. 8B collectively illustrate schematic diagrams representing the lane data before and after connecting with the line connector 709, in accordance with an example embodiment. FIG. 8A illustrates a schematic diagram 800A representing the lane data before connecting with the line connector 709. For example, the lane data 701 and the lane data 703 may be disconnected as the lane data 701 and the lane data 703 may be processed using the first model and the second model respectively.

FIG. 8B illustrates a schematic diagram 800B representing the lane data after connecting with the line connector 709. For example, the lane data 701 and the lane data 703 may be connected by sue of the line connector 709. Thus, in such a manner, the lane data 109A associated with the plurality of lane markings 119 may be optimized.

An end-to-end method of the present disclosure is briefly explained in FIG. 9.

FIG. 9) illustrates a block diagram 900 representing steps for optimization of the lane data 109A, in accordance with an example embodiment. FIG. 9 is explained in conjunction with elements of FIG. 1, FIG. 2, FIG. 3, FIG. 4, FIG. 5A, FIG. 5B, FIG. 6, FIG. 7A, FIG. 7B, FIG. 8A and FIG. 8B. It will be understood that each block of the block diagram 900 may be implemented by various means, such as hardware, firmware, processor, circuitry, and/or other communication devices associated with execution of software including one or more computer program instructions. For example, one or more of the procedures described above may be embodied by computer program instructions. In this regard, the computer program instructions which embody the procedures described above may be stored by a memory 203 of the system 101, employing an embodiment of the present disclosure and executed by a processor 201. As will be appreciated, any such computer program instructions may be loaded onto a computer or other programmable apparatus (for example, hardware) to produce a machine, such that the resulting computer or other programmable apparatus implements the functions specified in the blocks of the block diagram. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flow diagram blocks.

Accordingly, blocks of the flow diagram support combinations of means for performing the specified functions and combinations of operations for performing the specified functions for performing the specified functions. It will also be understood that one or more blocks of the diagram, and combinations of blocks in the diagram, may be implemented by special purpose hardware-based computer systems which perform the specified functions, or combinations of special purpose hardware and computer instructions. The block diagram 900 of FIG. 9 is implemented for the verification of the traffic incident. Fewer, more, or different steps may be provided.

At a step 901, the processor 201 may be configured to generate the border 307 between the first area 303 and the second area 305 of the topological area 300A. The generation of the border 307 is described in FIG. 3. At step 903, the processor 201 may determine the buffer area 309 for each of the first area 303 and the second area 305 of the topological area 300A. The determination of the buffer area 309 is described in FIG. 3. At step 905, the processor 201 may categorize the topological area 300A based on the generated border 307 and the determined buffer area 309. The categorization of the topological area 300A is described in FIG. 3.

At step 907, the processor 201 may be configured to determine the reference node 401A corresponding to the first end of the line string 401 associated with the lane and the non-reference node 401B corresponding to the second end point of the line string 401 associated with the lane. The determination of the reference node 401A and the non-reference node 401B is described in FIG. 4. At step 909, the processor 201 may categorize each location of the set of locations of the lane data 403 into at least the first area 303 or the second area 305. The categorization of the set of locations is described in FIG. 4.

At step 911, the processor 201 may be configured to determine the lane data 109A to be in the first group, the second group, or the third group. The third group is associated with both of the first area 303 and the second area 305. The determination of the lane data 109A in the different groups is described in FIG. 5A and FIG. 5B. At step 913, the processor 201 may be configured to truncate the lane data 507 determined in the third group. The truncation of the lane data 507 is described in FIG. 5A and FIG. 5B.

At step 915, the processor 201 may be configured to apply the first model on the lane data 505 and the first portion of the lane data 507 and the second model on the lane data 503 and the second portion of the lane data 507 to process the lane data 109A. The application of the different models is described in FIG. 5A and FIG. 5B.

At step 917, the processor 201 may be configured to determine the on-line threshold 705 that indicates the amount of the positional shift required by the lane data 703 and the lane data 705. The determination of the on-line threshold 705 is described in FIG. 7A. At step 919, the processor 201 may be configured to determine the gap threshold 707 that indicates the distance between the first location 701A of the lane data 701 and the second location 703A of the lane data 703. The determination of the gap threshold 707 is described in FIG. 7A.

At step 921, the processor 201 may be configured to generate the line connector 709 based on the on-line threshold 705 and the gap threshold 707. At step 923, the processor 201 may connect the lane data 701 and the lane data 703 using the line connector 709 to optimize the lane data 109A. The generation of the line connector 709 is described in FIG. 7B.

FIG. 10 illustrates a flow diagram of a method 1000 for optimization of the lane data 109A, in accordance with an example embodiment. It will be understood that each block of the flow diagram of the method 1000 may be implemented by various means, such as hardware, firmware, processor, circuitry, and/or other communication devices associated with execution of software including one or more computer program instructions. For example, one or more of the procedures described above may be embodied by computer program instructions. In this regard, the computer program instructions which embody the procedures described above may be stored by a memory 203 of the system 101, employing an embodiment of the present disclosure and executed by a processor 201. As will be appreciated, any such computer program instructions may be loaded onto a computer or other programmable apparatus (for example, hardware) to produce a machine, such that the resulting computer or other programmable apparatus implements the functions specified in the flow diagram blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flow diagram blocks.

Accordingly, blocks of the flow diagram support combinations of means for performing the specified functions and combinations of operations for performing the specified functions for performing the specified functions. It will also be understood that one or more blocks of the flow diagram, and combinations of blocks in the flow diagram, may be implemented by special purpose hardware-based computer systems which perform the specified functions, or combinations of special purpose hardware and computer instructions. The method 1000 illustrated by the flowchart diagram of FIG. 10 is used for the optimization of the plurality of lane markings 119. Fewer, more, or different steps may be provided.

At step 1001, the method 1000 comprises categorizing each location of the set of locations included in the lane data 109A of each lane marking of the plurality of lane markings 119, into at least one of the first area 115 or the second area 117 of the topological area 113. For example, the location of set of locations may be the end of the lane marking of the plurality of lane markings 119. Details of the categorization of each location of the set of locations are further provided, for example, in FIG. 4.

At step 1003, the method 1000 comprises determining the lane data 109A of each lane marking of the plurality of lane markings 119 to be in at least one of the first group, the second group or the third group, based on each categorized location of the set of locations. For example, the lane data 109A may be determined to be in different groups, such as the first group, the second group and the third group to identify the portion of the lane data 109A that lies in the first area 115, the portion of the lane data 109A that lies in the second area 117, or the portion of the lane data 109A that lies both the areas. Details of the determination of the lane data 109A in the different groups are further provided, for example, in FIG. 5A and FIG. 5B.

At a step 1005, the method 1000 comprises processing the lane data 109A associated with each lane marking of the plurality of lane markings 119 based on the determined first group, the second group or the third group. For example, the processing may include truncation of the lane data 109A, applying different models on the truncated lane data 109A and connecting the truncated lane data 109A by use of a line connector. Details of the processing of the lane data 109A are further provided, for example, in FIG. 5A, FIG. 5B, FIG. 7A and FIG. 7B.

The method 1000 may be implemented using corresponding circuitry. For example, the method 1000 may be implemented by an apparatus or system comprising a processor, a memory, and a communication interface of the kind discussed in conjunction with FIG. 2.

In some example embodiments, a computer programmable product may be provided. The computer programmable product may comprise at least one non-transitory computer-readable storage medium having stored thereon computer-executable program code instructions that when executed by a computer, cause the computer to execute the method 1000.

In an example embodiment, an apparatus for performing the method 1000 of FIG. 10 above may comprise a processor (e.g. the processor 201) configured to perform some or each of the operations of the method of FIG. 10 described previously. The processor may, for example, be configured to perform the operations (1001, 1003 and 1005) by performing hardware implemented logical functions, executing stored instructions, or executing algorithms for performing each of the operations. Alternatively, the apparatus may comprise means for performing each of the operations described above. In this regard, according to an example embodiment, examples of means for performing operations (1001, 1003 and 1005) may comprise, for example, the processor 201 which may be implemented in the system 101 and/or a device or circuit for executing instructions or executing an algorithm for processing information as described above.

Referring again to FIG. 1, in an example embodiment, the system 101 may be embodied in one or more of several ways as per the required implementation. For example, the system 101 may be embodied as a cloud-based service or a cloud-based platform. In each of such embodiments, the system 101 may be communicatively coupled to the components shown in FIG. 1 to carry out the desired operations and wherever required modifications may be possible within the scope of the present disclosure. The system 101 may be implemented in a device, such as a vehicle, where the vehicle may be an autonomous vehicle, or a semi-autonomous vehicle. Further, in one embodiment, the system 101 may be a standalone unit configured to process the lane data 109A. Alternatively, the system 101 may be coupled with an external device such as the autonomous vehicle or one or more imaging devices that captures the topological area 113. In an embodiment, the system 101 may also be referred to as a user equipment. In some example embodiments, the system 101 may be any user accessible device such as a mobile phone, a smartphone, a portable computer, and the like that are portable in themselves or as a part of another portable/mobile object such as the vehicle. The system 101 may comprise a processor, a memory, and a communication interface. The processor, the memory and the communication interface may be communicatively coupled to each other. In some example embodiments, the system 101 may be associated, coupled, or otherwise integrated with a vehicle of the user, such as an advanced driver assistance system (ADAS), a personal navigation device (PND), a portable navigation device, an infotainment system and/or other device that may be configured to provide route guidance and navigation related functions to a user of the vehicle. In such example embodiments, the system 101 may comprise a processing means such as a central processing unit (CPU), storage means such as on-board read only memory (ROM) and random access memory (RAM), sensors such as a GPS sensor, gyroscope, a light detection and ranging (LIDAR) sensor, a proximity sensor, motion sensors such as accelerometer, a display enabled user interface such as a touch screen display, and other components as may be required for specific functionalities of system 101. Additional, different, or fewer components may be provided. For example, the system 101 may be configured to execute and run mobile applications such as a messaging application, a browser application, a navigation application, and the like. For example, system 101 may be a dedicated vehicle (or a part thereof) for gathering the lane data 109A. For example, the system 101 may be a consumer vehicle (or a part thereof). In some example embodiments, the system 101 may serve the dual purpose of a data gatherer and a beneficiary device. The system 101 may be configured to capture sensor data, such as the lane data 109A associated with a road on which the vehicle may be traversing. In some scenarios, the system 101 may be configured to receive the sensor data from the one or more imaging sensors such as a satellite imaging device. The sensor data may be for example, image data of the plurality of lane markings 119 on the road. The sensor data may refer to sensor data collected from a sensor unit in the system 101. In accordance with an embodiment, the sensor data may refer to the data captured by the vehicle using sensors.

In some other embodiments, the system 101 may be an OEM (Original Equipment Manufacturer) cloud, such as the OEM cloud 109. The OEM cloud 109 may be configured to anonymize any data received from the system 101 before using the data for further processing, such as before sending the data to the mapping platform 103. In some embodiments, anonymization of data may be done by the mapping platform 103.

The mapping platform 103 may comprise the map database 109 for storing map data, for example, the lane data 109A and a processing server 111. The map data may further include data associated with vehicle's accidents on road/s, one or more of a road sign, or speed signs, or road objects on the link or path. Further, the map database 109 may store accident data, node data, road segment data, link data, point of interest (POI) data, link identification information, heading value records, or the like. Also, the map database 109 further includes speed limit data of each lane, cartographic data, routing data, and/or maneuvering data. Additionally, the map database 109 may be updated dynamically to cumulate real time traffic conditions. The real-time traffic conditions may be collected by analyzing the location transmitted to the mapping platform 103 by a large number of road users travelling by vehicles through the respective user devices of the road users. In one example, by calculating the speed of the road users along a length of road, the mapping platform 103 may generate a live traffic map, which is stored in the map database 109 in the form of real time traffic conditions. In one embodiment, the map database 109 may further store historical traffic data that includes travel times, accident prone areas, areas with least and maximum accidents, average speeds and probe counts on each road or area at any given time of the day and any day of the year. According to some example embodiments, the road segment data records may be links or segments representing roads, streets, or paths, as may be used in calculating a route or recorded route information for determination of one or more personalized routes to avoid a zone/route with the predicted accident. The node data may be end points corresponding to the respective links or segments of road segment data. The road link data and the node data may represent a road network used by vehicles such as cars, trucks, buses, motorcycles, and/or other entities. Optionally, the map database 109 may contain path segment and node data records, such as shape points or other data, such as the lane markings that may represent pedestrian paths, links, or areas in addition to or instead of the vehicle road record data, for example. The road/link segments and nodes can be associated with attributes, such as geographic coordinates, street names, address ranges, speed limits, turn restrictions at intersections, and other navigation related attributes, as well as POIs, such as fueling stations, hotels, restaurants, museums, stadiums, offices, auto repair shops, buildings, stores, parks, etc. The map database 109 may also store data about the POIs and their respective locations in the POI records. The map database 109 may additionally store data about places, such as cities, towns, or other communities, and other geographic features such as bodies of water, mountain ranges, etc. Such place or feature data can be part of the POI data or can be associated with POIs or POI data records (such as a data point used for displaying or representing a position of a city). In addition, the map database 109 may include event data (e.g., traffic incidents, construction activities, scheduled events, unscheduled events, vehicle accidents, diversions etc.) associated with the POI data records or other records of the map database 109 associated with the mapping platform 103. Optionally, the map database 109 may contain path segment and node data records or other data that may represent pedestrian paths or areas in addition to or instead of the autonomous vehicle road record data. In an embodiment, the map database 109 may be a source-available document-oriented database.

In some embodiments, the map database 109 may be a master map database stored in a format that facilitates updating, maintenance and development. For example, the master map database or data in the master map database may be in an Oracle spatial format or other spatial format, such as for development or production purposes. The Oracle spatial format or development/production database may be compiled into a delivery format, such as a geographic data files (GDF) format. The data in the production and/or delivery formats may be compiled or further compiled to form geographic database products or databases, which may be used in end user navigation devices or systems.

For example, geographic data may be compiled (such as into a platform specification format (PSF) format) to organize and/or configure the data for performing navigation-related functions and/or services in an event of a predicted vehicle's accident, such as route calculation, route guidance, map display, speed calculation, distance and travel time functions, and other functions, by a navigation device, such as by the system 101. The navigation-related functions may correspond to vehicle navigation, pedestrian navigation, or other types of navigation to avoid a zone where the vehicle accident has been predicted by the system 101. The compilation to produce the end user databases may be performed by a party or entity separate from the map developer. For example, a customer of the map developer, such as a navigation device developer or other end user device developer, may perform compilation on a received map database in a delivery format to produce one or more compiled navigation databases.

As mentioned above, the map database 109 may be a master geographic database, but in alternate embodiments, the map database 109 may be embodied as a client-side map database and may represent a compiled navigation database that may be used in the system 101 to provide navigation and/or map-related functions in an event of a predicted vehicle's accident. For example, the map database 109 may be used with the system 101 to provide an end user with navigation features. In such a case, the map database 109 may be downloaded or stored locally (cached) on the system 101.

The processing server 111 may comprise processing means, and communication means. For example, the processing means may comprise one or more processors configured to process requests received from the system 101. The processing means may fetch map data from the map database 109 and transmit the same to the system 101 via the OEM cloud 105 in a format suitable for use by the system 101. In one or more example embodiments, the mapping platform 103 may periodically communicate with the system 101 via the processing server 111 to update a local cache of the map data stored on the system 101. Accordingly, in some example embodiments, the map data may also be stored on the system 101 and may be updated based on periodic communication with the mapping platform 103.

The network 107 may be wired, wireless, or any combination of wired and wireless communication networks, such as cellular, Wi-Fi, internet, local area networks, or the like. In one embodiment, the network 107 may include one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks (for e.g. LTE-Advanced Pro), 5G New Radio networks, ITU-IMT 2020 networks, code division multiple access (CDMA), wideband code division multiple access (WCDMA), wireless fidelity (Wi-Fi), wireless LAN (WLAN), Bluetooth, Internet Protocol (IP) data casting, satellite, mobile ad-hoc network (MANET), and the like, or any combination thereof. In an example, the mapping platform 103 may be integrated into a single platform to provide a suite of mapping and navigation related applications for OEM devices, such as the user devices and the system 101. The system 101 may be configured to communicate with the mapping platform 103 over the network 107. Thus, the mapping platform 103 may enable provision of cloud-based services for the system 101, such as, storing the lane marking data in the OEM cloud 105 in batches or in real-time.

Referring again to FIG. 2, the processor 201 may be embodied in a number of different ways. For example, the processor 201 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor 201 may include one or more processing cores configured to perform independently. A multi-core processor may enable multiprocessing within a single physical package. Additionally, or alternatively, the processor 201 may include one or more processors configured in tandem via the bus to enable independent execution of instructions, pipelining and/or multithreading.

In some embodiments, the processor 201 may be configured to provide Internet-of-Things (IOT) related capabilities to users of the system 101. In some embodiments, the users of the system 101 may be or correspond to the autonomous or the semi-autonomous vehicle. The IoT related capabilities may in turn be used to provide smart navigation solutions and updating the map. The system 101 may be accessed using the communication interface 205. The communication interface 205 may provide an interface for accessing various features and data stored in the system 101.

Additionally, or alternatively, the processor 201 may include one or more processors capable of processing large volumes of workloads and operations to provide support for big data analysis. In an example embodiment, the processor 201 may be in communication with the memory 203 via a bus for passing information among components coupled to the system 101.

The memory 203 may be non-transitory and may include, for example, one or more volatile and/or non-volatile memories. In other words, for example, the memory 203 may be an electronic storage device (for example, a computer readable storage medium) comprising gates configured to store data (for example, bits) that may be retrievable by a machine (for example, a computing device like the processor 201). The memory 203 may be configured to store information, data, content, applications, instructions, or the like, for enabling the apparatus to carry out various functions in accordance with an example embodiment of the present disclosure. For example, the memory 203 may be configured to buffer input data for processing by the processor 201. As exemplarily illustrated in FIG. 2, the memory 203 may be configured to store instructions for execution by the processor 201. As such, whether configured by hardware or software methods, or by a combination thereof, the processor 201 may represent an entity (for example, physically embodied in circuitry) capable of performing operations according to an embodiment of the present invention while configured accordingly. Thus, for example, when the processor 201 is embodied as an ASIC, FPGA or the like, the processor 201 may be specifically configured hardware for conducting the operations described herein. Alternatively, as another example, when the processor 201 is embodied as an executor of software instructions, the instructions may specifically configure the processor 201 to perform the algorithms and/or operations described herein when the instructions are executed. However, in some cases, the processor 201 may be a processor specific device (for example, a mobile terminal or a fixed computing device) configured to employ an embodiment of the present disclosure by further configuration of the processor 201 by instructions for performing the algorithms and/or operations described herein. The processor 201 may include, among other things, a clock, an arithmetic logic unit (ALU) and logic gates configured to support operation of the processor 201.

The communication interface 205 may comprise input interface and output interface for supporting communications to and from the system 101 or any other component with which the system 101 may communicate. The communication interface 205 may be any means such as a device or circuitry embodied in either hardware or a combination of hardware and software that is configured to receive and/or transmit data to/from a communications device in communication with the system 101. In this regard, the communication interface 205 may include, for example, an antenna (or multiple antennae) and supporting hardware and/or software for enabling communications with a wireless communication network. Additionally, or alternatively, the communication interface 205 may include the circuitry for interacting with the antenna(s) to cause transmission of signals via the antenna(s) or to handle receipt of signals received via the antenna(s). In some environments, the communication interface 205 may alternatively or additionally support wired communication. As such, for example, the communication interface 205 may include a communication modem and/or other hardware and/or software for supporting communication via cable, digital subscriber line (DSL), universal serial bus (USB) or other mechanisms. In some embodiments, the communication interface 205 may enable communication with a cloud-based network to enable deep learning.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

We claim:

1. A system for optimization of lane data, the system comprising:
at least one non-transitory memory configured to store computer executable instructions; and
at least one processor configured to execute the computer executable instructions to:
categorize each location of a set of locations included in the lane data of each lane marking of the plurality of lane markings, into at least one of: a first area or a second area of a topological area:
determine the lane data of each lane marking to be in at least one of: a first group, a second group or a third group, based on each categorized location of the set of locations; and
process the lane data associated with each lane marking of the plurality of lane markings based on the determined first group, the second group or the third group.

2. The system of claim 1, wherein the at least one processor is further configured to categorize the topological area associated with a map, into the first area and the second area, based on a type of the topological area.

3. The system of claim 2, wherein, to categorize the topological area, the at least one processor is further configured to:
generate a border between the first area and the second area to separate the first area from the second area; and
determine a buffer area for each of the first area and the second area, wherein the buffer area is further utilized to categorize the set of locations into at least one of: the first area or the second area of the topological area.

4. The system of claim 2, wherein the type of the topological area comprises one of:
an intersection or a non-intersection, a ramp area or a non-ramp area, and a highway or a non-highway.

5. The system of claim 3, wherein the first area corresponds to one of: the intersection, the ramp area, or the highway, and
the second area corresponds to on one of: the non-intersection, the non-ramp area, or the non-highway.

6. The system of claim 1, wherein, to process the lane data, the at least one processor is further configured to:
truncate the lane data of one or more lane markings of the plurality of lane markings determined in the third group, wherein the third group is associated with both of the first area and the second area:
apply a first model on the lane data determined in the first group and a first portion of the truncated lane data determined in the third group, and a second model on the lane data determined in the second group and a second portion of the truncated lane data determined in the third group; and
connect the truncated lane data by use of a generated line connector to optimize the lane data.

7. The system of claim 6, wherein the at least one processor is further configured to:
determine an on-line threshold that indicates an amount of a positional shift required by the lane data of first lane marking and a second lane marking of the one or more lane markings:
determine a gap threshold that indicates a distance between a first location of the lane data of the first lane marking and a second location of the lane data of the second lane marking; and
generate the line connector to optimize the lane data of the first lane marking and the second lane marking based on at least one of: the determined on-line threshold or the determined gap threshold.

8. The system of claim 1, wherein, to categorize each location of the set of locations, the at least one processor is further configured to:
determine a reference node corresponding to a first end of a line string associated with a lane and a non-reference node corresponding to a second end point of the line string associated with the lane, wherein the plurality of lane markings are associated with the lane; and
categorize at least a first location of the set of locations into the first area based on a determination that:
the first location lies within a predefined threshold of at least one of: the reference node or the non-reference node, wherein the reference node and the non-reference node are associated with the first area; and
the first location lies within a buffer area for the first area, wherein the buffer area is determined with respect to the reference node and the non-reference node.

9. The system of claim 8, wherein the at least one processor is further configured to categorize the first location into the first area based on at least one of: a map matching method or a point-in polygon method.

10. The system of claim 8, wherein, to process the lane data, the at least one processor is further configured to truncate the lane data of one or more lane markings of the plurality of lane markings determined in the third group in two lane markings,
based on a determination that the first location of the lane data of each lane marking of the one or more lane markings lies within the predefined threshold of at least one of: the reference node or the non-reference node, and
a second location of the lane data of each lane marking is categorized in the second area.

11. The system of claim 10, wherein, to process the lane data, the at least one processor is further configured to truncate the lane data of the one or more lane markings in three lane markings, based on a determination that the first location of the lane data of each lane marking lies within the predefined threshold of the reference node, and the second location of the lane data of each lane marking lies within the predefined threshold of the non-reference node.

12. A method for optimization of lane data, the method comprising:
categorizing each location of a set of locations included in the lane data of each lane marking of the plurality of lane markings, into at least one of: a first area or a second area of a topological area;
determining the lane data of each lane marking to be in at least one of: a first group, a second group or a third group, based on each categorized location of the set of locations; and
processing the lane data associated with each lane marking of the plurality of lane markings based on the determined first group, the second group or the third group.

13. The method of claim 12, further comprising:
generating a border between the first area and the second area to separate the first area from the second area; and
determining a buffer area for each of the first area and the second area, wherein the buffer area is further utilized to categorize the set of locations into at least one of: the first area or the second area of the topological area, to categorize the topological area.

14. The method of claim 12, further comprising:
truncating the lane data of one or more lane markings of the plurality of lane markings determined in the third group, wherein the third group is associated with both of the first area and the second area;
applying a first model on the lane data determined in the first group and a first portion of the truncated lane data determined in the third group, and a second model on the lane data determined in the second group and a second portion of the truncated lane data determined in the third group; and
connecting the truncated lane data by use of a generated line connector to optimize the lane data, to process the lane data.

15. The method of claim 14, further comprising:
determining an on-line threshold that indicates an amount of a positional shift required by the lane data of first lane marking and a second lane marking of the one or more lane markings;
determining a gap threshold that indicates a distance between a first location of the lane data of the first lane marking and a second location of the lane data of the second lane marking; and
generating the line connector to optimize the lane data of the first lane marking and the second lane marking based on at least one of: the determined on-line threshold or the determined gap threshold.

16. The method of claim 14, further comprising:
determining a reference node corresponding to a first end of a line string associated with a lane and a non-reference node corresponding to a second end point of the line string associated with the lane, wherein the plurality of lane markings are associated with the lane; and
categorizing at least a first location of the set of locations into the first area based on a determination that;
the first location lies within a predefined threshold of at least one of: the reference node or the non-reference node, wherein the reference node and the non-reference node are associated with the first area; and
the first location lies within a buffer area for the first area, wherein the buffer area is determined with respect to the reference node and the non-reference node.

17. The method of claim 16, further comprising categorizing the first location into the first area based on at least one of: a map matching method or a point-in polygon method.

18. The method of claim 16, further comprising truncating the lane data of one or more lane markings of the plurality of lane markings determined in the third group in two lane markings,
based on a determination that the first location of the lane data of each lane marking of the one or more lane markings lies within the predefined threshold of at least one of: the reference node or the non-reference node, and
a second location of the lane data of each lane marking is categorized in the second area, to process the lane data.

19. The method of claim 18, further comprising truncating the lane data of the one or more lane markings in three lane markings, based on a determination that the first location of the lane data of each lane marking lies within the predefined threshold of the reference node, and the second location of the lane data of each lane marking lies within the predefined threshold of the non-reference node, to process the lane data.

20. A computer programmable product comprising a non-transitory computer readable medium having stored thereon computer executable instruction which when executed by one or more processors, cause the one or more processors to carry out operations for optimization of lane data, the operations comprising:
categorizing each location of a set of locations included in the lane data of each lane marking of the plurality of lane markings, into at least one of: a first area or a second area of a topological area;
determining the lane data of each lane marking to be in at least one of: a first group, a second group or a third group, based on each categorized location of the set of locations; and
processing the lane data associated with each lane marking of the plurality of lane markings based on the determined first group, the second group or the third group.
